(19) United States
(12) Patent Application Publication
(10) Pub. No.: US 2018/0278117 A1
(43) Pub. Date: Sep. 27, 2018

(54) ELECTRIC MOTOR

(71) Applicant: FANUC CORPORATION, Yamanashi (JP)

(72) Inventor: Kyouhei Katsuki, Yamanashi-ken (JP)

(73) Assignee: FANUC CORPORATION, Yamanashi (JP)

(21) Appl. No.: 15/924,638

(22) Filed: Mar. 19, 2018

(30) Foreign Application Priority Data
Mar. 21, 2017 (JP) 2017-054001

(51) Int. Cl. H02K 5/10; H02K 5/173; H02K 5/22; H02K 7/08; H02K 7/14; H02K 21/12

(52) U.S. Cl. CPC H02K 5/10; H02K 5/1732; H02K 21/12; H02K 7/083; H02K 7/14; H02K 5/225

(57) ABSTRACT

An electric motor is equipped with a stator core fixed to a housing, a rotor core which rotates integrally with a shaft, and a first bearing, having an outer race with an outer circumferential surface thereof placed in abutment against the housing, and an inner race with an inner circumferential surface thereof placed in abutment against the shaft, and wherein the bearing rotatably supports the shaft with respect to the housing. Through holes is provided in the outer race, the through hole penetrating the outer race in an axial direction thereof.

### CROSS-REFERENCE TO RELATED APPLICATION

This application is based upon and claims the benefit of priority from Japanese Patent Application No. 2017-054001 filed on Mar. 21, 2017, the contents of which are incorporated herein by reference.

### BACKGROUND OF THE INVENTION

### Field of the Invention

The present invention relates to an electric motor.

### Description of the Related Art

In Japanese Laid-Open Patent Publication No. 2016-086561, an electric motor is disclosed in which compressed air is supplied into the electric motor in order to prevent foreign matter from entering into the interior of the electric motor. The compressed air which is supplied into the electric motor passes through an axially extending groove formed in a bearing support surface of a housing, and is discharged to the exterior of the electric motor. In Japanese Laid-Open Utility Model Publication No. 06-045118, a lubricating device for a bearing is disclosed, in which the bearing includes through holes that extend in an axial direction along an inner race (inner ring) of the bearing.

### SUMMARY OF THE INVENTION

In Japanese Laid-Open Patent Publication No. 2016-086561, since the groove is formed in the bearing support surface that supports the bearing, it is impossible to ensure adhesion between the bearing and the bearing support surface, and there is a concern that the bearing cannot be stably supported. In order to solve the problem of Japanese Laid-Open Patent Publication No. 2016-086561, if through holes were formed in an inner race of the bearing, as in Japanese Laid-Open Utility Model Publication No. 06-045118, since the inner race undergoes rotation, there is a concern that rotational balance would be destroyed due to providing the through holes, and abnormal sounds or the like could occur.

The present invention has been devised taking into consideration the aforementioned problems, and has the object of providing an electric motor in which it is possible to secure rotational balance of an inner race of a bearing while the bearing is stably supported.

An aspect of the present invention is characterized by an electric motor, comprising a stator core fixed to a housing, a rotor core which rotates integrally with a shaft, and a bearing, having an outer race with an outer circumferential surface thereof placed in abutment against the housing, and an inner race with an inner circumferential surface thereof placed in abutment against the shaft, and wherein the bearing rotatably supports the shaft with respect to the housing. Through holes is provided in the outer race (44), the through hole (44b) penetrating the outer race (44) in an axial direction thereof.

According to the present invention, it is possible to secure rotational balance of the inner race of the bearing while the bearing is stably supported.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an axial cross-sectional view of an electric motor according to a first embodiment of the present invention; and

FIG. 2 is an enlarged view of the vicinity of a first bearing of the first embodiment.

### DESCRIPTION OF THE PREFERRED EMBODIMENTS

The present invention will be described below through various embodiments of the present invention. The illustrative embodiments are not intended to limit the present invention as defined in the appended claims. Furthermore, all of the combinations of features discussed in the illustrative embodiments might not be absolutely necessary for achieving the inventive solution.

### First Embodiment

### [Structure of the Electric Motor]

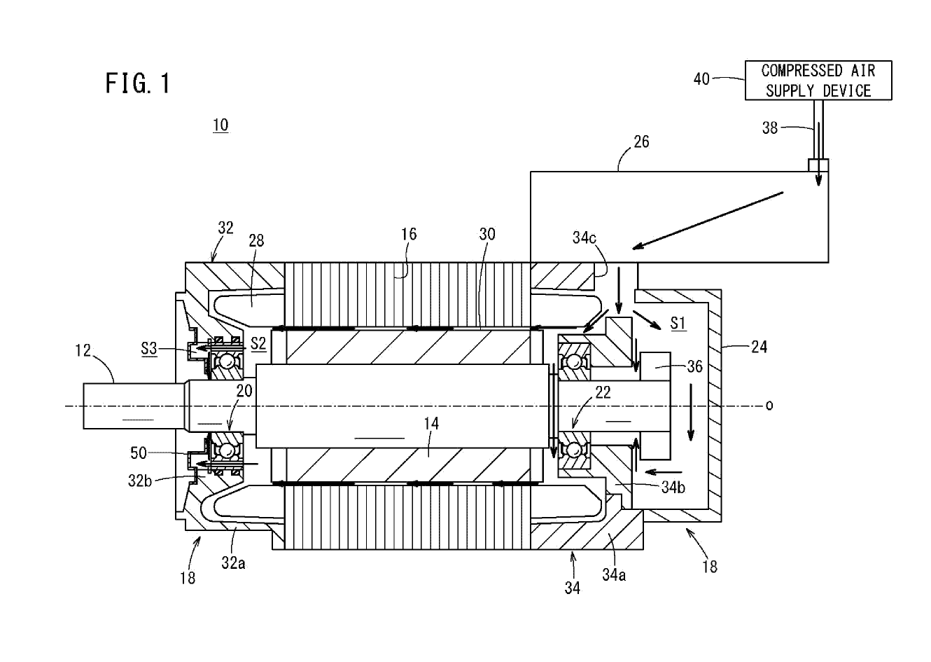

FIG. 1 is an axial cross-sectional view showing the electric motor 10 of the present embodiment. The electric motor 10 includes a shaft 12, a rotor core 14, a stator core 16, a housing 18, a first bearing 20, a second bearing 22, a rear cover 24, and a terminal box 26.

Hereinafter, a direction in which the axis of rotation O of the shaft 12 extends will be referred to as an axial direction. Further, when the electric motor 10 is observed in the state shown in FIG. 1, the left side thereof will be referred to as a front side, and the right side thereof will be referred to as a rear side. Furthermore, the direction perpendicular to the axis of rotation O and which extends radially will be referred to as a diametrical direction, and the direction of rotation about the axis of rotation O will be referred to as a circumferential direction.

The rotor core 14 is integrally and rotatably fixed to the shaft 12. The rotor core 14 is made up of a plurality of magnets which are aligned in the circumferential direction, and arranged in a manner so that the magnetic poles of adjacently disposed magnets in the circumferential direction differ from each other. The stator core 16 is constituted from laminated steel plates made of a magnetic material, and a coil 28 is wound around the stator core 16. The rotor core 14 is disposed on the inner circumference of the stator core 16, and an air gap 30, which provides a gap in the radial direction, is disposed between the inner circumference of the stator core 16 and the outer circumference of the rotor core 14.

The stator core 16 is supported by the housing 18. The housing 18 has a first housing 32 and a second housing 34. The first housing 32 is fixed to the front side of the stator core 16, and the second housing 34 is fixed to the rear side of the stator core 16.

The first housing 32 includes a main body portion 32a formed in an annular shape, and a flange portion 32b formed to extend radially inward from the main body portion 32a. The stator core 16 is fixed to a rear end surface of the main body portion 32a. The first bearing 20 is mounted on an inner circumferential surface of the flange portion 32b of the first housing 32.

The second housing 34 includes a main body portion 34a formed in an annular shape, and a bearing support member 34b formed separately from the main body portion 34a and which is fixed to an inner circumferential side of the main body portion 34a. The stator core 16 is fixed to a front end surface of the main body portion 34a. The second bearing 22 is mounted in the bearing support member 34b.

The shaft 12 is rotatably supported by the first bearing 20 more on the front side than the rotor core 14. An end portion on the front side of the shaft 12 protrudes to the exterior of the first housing 32. The front side of the shaft 12 is connected to a spindle of a non-illustrated machine tool, or to a ball screw shaft of a work table or the like.

The shaft 12 is rotatably supported by the second bearing 22 more on the rear side than the rotor core 14. An end portion on the rear side of the shaft 12 protrudes to the exterior of the second housing 34. An encoder 36, which detects a rotational position and a rotational speed of the shaft 12, is disposed on the rear end of the shaft 12.

A rear cover 24 is provided on the rear side of the main body portion 34a of the second housing 34, in a manner so as to cover the opening of the main body portion 34a. The terminal box 26 is fixed to the outer circumferential side of the second housing 34. The interior of the terminal box 26 and the interior of the second housing 34 communicate with each other through a communication hole 34c, which is formed in the main body portion 34a of the second housing 34. A non-illustrated cable for supplying electrical power to the coil 28 is drawn into the terminal box 26 from the exterior thereof, and the cable extends through the communication hole 34c into the second housing 34, and is connected to the coil 28.

In the terminal box 26, an air flow passage 38 is provided that communicates with the interior of the terminal box 26. The air flow passage 38 is connected to a compressed air supply device 40 which is disposed externally of the housing 18. The compressed air supply device 40 is constituted by a pump, and air compressed by the compressed air supply device 40 is supplied to the interior of the second housing 34 via the air flow passage 38, the terminal box 26, and the communication hole 34c.

[Detailed Configuration in the Vicinity of the First Bearing]

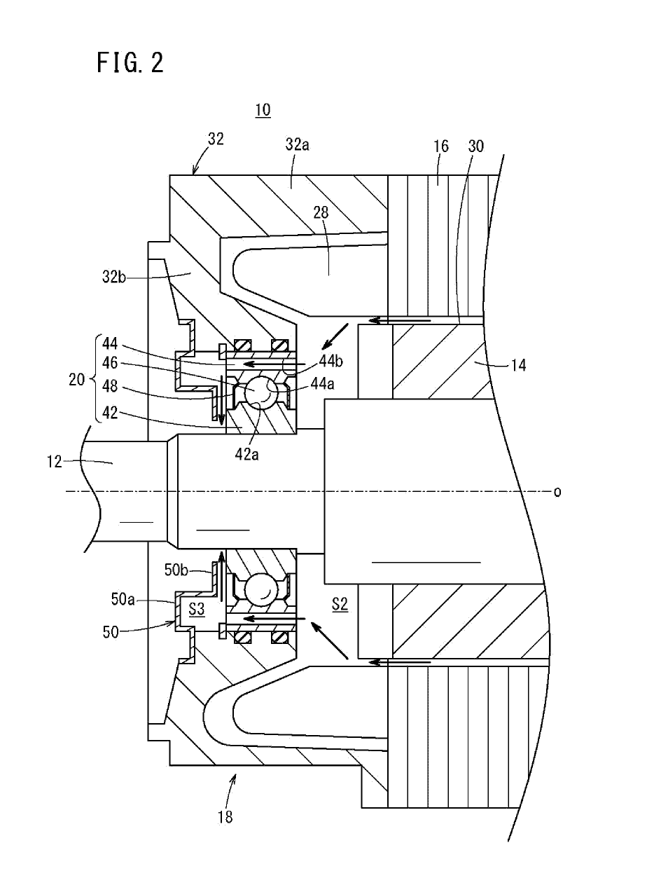

FIG. 2 is an enlarged view of the vicinity of the first bearing 20. The first bearing 20 is a ball bearing, and has an inner race 42, an outer race 44, a plurality of balls 46, and a retainer 48.

The inner race 42 is an annular member, and the shaft 12 is inserted along the inner circumference thereof. The inner race 42 rotates integrally with the shaft 12. The outer race 44 is an annular member, and an outer peripheral surface thereof is fixed to the flange portion 32b of the first housing 32. In a state of being retained by the retainer 48, the plurality of balls 46 are capable of rolling between a raceway surface 42a formed on the outer circumferential surface of the inner race 42, and a raceway surface 44a formed on the inner circumferential surface of the outer race 44. A plurality of through holes 44b, which penetrate in the axial direction, are formed along the circumferential direction in the outer race 44.

An annular wall 50 is fixed to the flange portion 32b of the first housing 32 and more on the front side than the first bearing 20. A projecting part 50a, which projects in a direction away from the first bearing 20, is formed on the outer circumferential side of the annular wall 50, and a bent part 50b, which is bent in a direction to approach toward the first bearing 20, is formed on the inner circumferential side of the annular wall 50. The projecting part 50a is formed at a position that overlaps in the radial direction with the outer race 44, and the bent part 50b is formed at a position that overlaps in the radial direction with a range between the inner circumference of the outer race 44 and the outer circumference of the inner race 42.

### [Air Purge Function]

As has been described above, the electric motor 10 of the present embodiment is used in an environment of being connected to a spindle of a machine tool, or to a ball screw shaft or the like, in which foreign matter such as chips or cutting fluid or the like is scattered. If such foreign matter were to enter into the electric motor 10, there is a possibility that malfunctioning could occur, and therefore, it is necessary to prevent such foreign matter from entering into the electric motor 10. With the electric motor 10 according to the present embodiment, in accordance with an air purge function in which compressed air, which is supplied to the interior of the electric motor 10, is blown against the outer circumference of the shaft 12 in the vicinity of the first bearing 20, it is possible to prevent such foreign matter from entering into the electric motor 10.

The compressed air supplied from the compressed air supply device 40 to the air flow passage 38 passes through the terminal box 26, and is sent from the communication hole 34c into a space S1 formed by the second housing 34 and the rear cover 24. Thereafter, the compressed air passes through the air gap 30 between the inner circumference of the stator core 16 and the outer circumference of the rotor core 14, and is sent into a space S2 formed by the first housing 32. In addition, the compressed air passes through the through holes 44b formed in the outer race 44 of the first bearing 20, and is sent into a space S3 formed by the first bearing 20 and the projecting part 50a of the annular wall 50. The compressed air that is sent into the space S3 is blown toward the outer circumferential surface of the shaft 12 from a gap formed between the first bearing 20 and the bent part 50b of the annular wall 50.

In order to prevent entry of foreign matter, it may be considered to provide a seal member or a labyrinth mechanism between the shaft 12 and the first housing 32 at a location in front of the first bearing 20. However, since the shaft 12 rotates at high speed, the durability of such a seal member cannot be adequately secured, and it has been impossible to withstand operation over a prolonged time period. Further, since a large amount of foreign matter is scattered, such a labyrinth mechanism cannot sufficiently prevent entry of such foreign matter. According to the present embodiment, the compressed air is blown toward and against the outer circumferential surface of the shaft 12 at a portion thereof in front of the first bearing 20 and adjacent to the first bearing 20, whereby the sealing performance of the electric motor 10 is enhanced, and entry of foreign matter is prevented.

[Operations and Effects]

In order to enhance the sealing performance of the electric motor 10, it is necessary to blow a sufficient amount of compressed air toward the outer circumferential surface of the shaft 12. More specifically, it is necessary to supply a sufficient amount of compressed air from the space S2 into the space S3. Since the gap exists between the inner race 42 and the outer race 44 of the first bearing 20, the compressed air can pass between the inner race 42 and the outer race 44. However, by the compressed air that only passes between the inner race 42 and the outer race 44, it has been impossible to supply a sufficient amount of compressed air into the space S3.

In order to supply an adequate amount of compressed air into the space S3, a communication passage may be formed to enable communication between the space S2 and the space S3. It may be considered to form a groove which extends in the axial direction at a portion where the flange portion 32b of the first housing 32 and the outer circumferential surface of the outer race 44 are in contact with each other. However, since the flange portion 32b and the outer circumferential surface of the outer race 44 are not in contact with each other at such a portion where the groove is formed, when the shaft 12 undergoes rotation, there is a concern that pulsation could occur in the first bearing 20, leading to a decrease in structural integrity of the first bearing 20. Further, it may be considered to form through holes which extend in the axial direction in the inner race 42, and which serve as communication passages. However, since the inner race 42 rotates integrally with the shaft 12, there is a concern that rotational balance will be destroyed due to formation of the through holes, and that abnormal noises or the like could be generated. Further, because the through holes rotate together with the inner race 42, it is difficult for the compressed air to enter into the through holes, and there is a concern that an adequate amount of compressed air cannot be ensured.

Thus, according to the present embodiment, the through holes 44b are formed to penetrate in the axial direction through the outer race 44. Consequently, a sufficient amount of compressed air can be blown toward and against the outer circumferential surface of the shaft 12, and the sealing performance of the electric motor 10 can be enhanced. Further, since the through holes 44b are formed in the interior of the outer race 44, the outer circumference of the outer race 44 can be kept in contact with the flange portion 32b over the entire circumference thereof, and pulsation of the first bearing 20 can be suppressed. Furthermore, because the outer race 44 itself does not undergo rotation, there is no concern that rotational balance will be destroyed due to providing the through holes 44b.

### OTHER EMBODIMENTS

While the present invention has been described with reference to a particular embodiment, the technical scope of the present invention is not limited to the scope defined by the above embodiment. It goes without saying that various modifications or improvements are capable of being added to the above embodiment. It is clear from the scope of the claims that other modes to which such modifications or improvements have been added can be included within the technical scope of the present invention.

For example, according to the first embodiment, compressed air is supplied to the interior of the electric motor 10. However, the supplied fluid is not limited to air, and various fluids may be appropriately selected in consideration of the rotational resistance of the shaft 12 in the interior of the electric motor 10. Further, the concept of the present invention is not limited to being applied to an electric motor that is used in a machine tool, but may also be applied to an electric motor used in any environment in which foreign matter is scattered.

### Technical Concept Obtained from the Embodiments

The technical concept which can be grasped from the above-described embodiments will be described below.

The electric motor (10) is equipped with the stator core (16) which is fixed to the housing (18), the rotor core (14) which rotates integrally with the shaft (12), and the bearing (20), having the outer race (44) with an outer circumferential surface thereof placed in abutment against the housing (18), and the inner race (42) with an inner circumferential surface thereof placed in abutment against the shaft (12). The bearing (20) rotatably supports the shaft (12) with respect to the housing (18). Further, the through holes (44b) is provided in the outer race (44), the through hole (44b) penetrating the outer race (44) in an axial direction thereof. In accordance with these features, it is possible to stably support the bearing (20) on the housing (18) while avoiding a deterioration in the rotational balance of the bearing (20).

The above-described electric motor (10) may comprise the fluid supply unit (40) which is adapted to supply a compressed fluid into the housing (18). In accordance with this feature, a sufficient amount of compressed fluid can be blown out to the exterior of the electric motor (10), and the sealing performance of the electric motor (10) can be enhanced.

In the above-described electric motor (10), the fluid supply unit (40) may be disposed externally of the housing (18). Thus, it is possible to dispose the relatively large-scale fluid supply unit (40) externally of the housing, and thereby improve the ability to mount or install the electric motor (10).

What is claimed is:

1. An electric motor, comprising:
a stator core fixed to a housing;
a rotor core which rotates integrally with a shaft; and
a bearing, having an outer race with an outer circumferential surface thereof placed in abutment against the housing, and an inner race with an inner circumferential surface thereof placed in abutment against the shaft, and wherein the bearing rotatably supports the shaft with respect to the housing;
wherein a through hole is provided in the outer race, the through hole penetrating the outer race in an axial direction thereof.

2. The electric motor according to claim 1, comprising a fluid supply unit adapted to supply a compressed fluid into the housing.

3. The electric motor according to claim 2, wherein the fluid supply unit is disposed externally of the housing.
